(19) United States
(12) Patent Application Publication
(10) Pub. No.: US 2015/0095425 A1
(43) Pub. Date: Apr. 2, 2015

(54) METHOD AND SYSTEM FOR SHARING AND EXCHANGE OF DIGITAL CONTENT

(71) Applicant: Thor Entertainment Group, LLC, Chicago, IL (US)

(72) Inventor: Bradley G. Thor, JR., Nashville, TN (US)

(21) Appl. No.: 14/477,568

(22) Filed: Sep. 4, 2014

Related U.S. Application Data
(60) Provisional application No. 61/873,557, filed on Sep. 4, 2013.

(51) Int. Cl. H04L 29/08

(52) U.S. Cl. CPC H04L 67/104; H04L 67/306
USPC 709/204

(57) ABSTRACT

A method and system for the sharing of information between individuals, including, for example, information regarding digital content utilized by users of the system. In one embodiment, a system includes, for example, a first device, a second device, and a network. The first device is configured to record digital content utilized by a first user on the first device. The second device is configured to record digital content utilized by a second user on the second device. The network is configured for two-way communications between the first device and the second device, the communications including records that indicate at least a portion of the digital content utilized by the other of the first user and the second user

### RELATED APPLICATIONS

This application benefits from and claims priority to U.S. Application No. 61/873,557, filed Sep. 4, 2013, which is incorporated herein by reference in its entirety.

### BACKGROUND OF THE INVENTION

When the reading of printed media, such as, for example, physical medium having printed matter, among others, was more prevalent, a person often could readily ascertain what others around him/her were reading. For example, an individual may be able to glance at another, relatively nearby, person from a variety of different locations and/or angles and identify the type of printed media that that person was reading, such as a book, magazine, or newspaper, among other printed media. Further, the individual may also be able to identify specifics regarding the printed media being read by that person, such as, for example, identifying the title and/or author shown on a book jacket, the name on a magazine cover, a photo relating to the subject matter of the article, or the title of an article. In such situations, the individual may have been able to identify what a number of people in his/her vicinity were reading without needing to be up close and/or personal with those people.

The ability to readily identify what others were reading could provide a source of ideas and/or recommendations for future reading material. For example, by being able to readily ascertain what others were reading, one may be able to determine whether there was a particular book or author that are number of people appeared to be reading. Moreover, seeing a number of people with same reading material may provide notice to the individual of a popular and/or new book, article, and/or author. Indeed, the fact that a number of people may have seemed to be reading a particular item, such as a book, newspaper, or magazine, often was an excellent sales tool for the people behind that item, such as the author and publisher, among others.

Today, however, the use of electronic devices and e-Reading has, in many instances, replaced traditional printed media. Moreover, in many instances, people view their reading materials on a display or screen of a mobile electronic device, such as, for example, smart phones, tablets, and portable computing devices, among other electronic devices. Yet, with the possible exception of the image displayed on the display, an individual may not be able to readily ascertain what someone else is reading on a mobile electronic device. For example, the size and shape of the mobile electronic device may not allow someone to identify the type of content the reader is viewing, such as whether the reader is viewing a book, magazine, newspaper, or internet site, among others. Further, the exterior surfaces of the mobile device are typically unlikely to provide specific information regarding the content being read, such as the author or title of the content. Indeed, often times, such information may not be shown on the display, such as when the user has, on their electronic device, scrolled away from or otherwise proceeded past images and/or text containing such information. And even if such information is present on the screen of the mobile electronic device, an individual's ability to see or recognize that information often depends on how the user is holding and/or has positioned the electronic device and the angle and distance at which the individual is positioned from the screen.

Similar issues may also arise with other types of content. For example, individuals often listen to and/or view movies, videos, shows, and music, among other content, on their mobile electronic devices, desktop computers, as well as other devices. However, often times an identification and/or recognition of such content by others is difficult. For example, the user may be utilizing headphones so as to prevent and/or minimize the sharing of at least audible portions of the content with others. Additionally, again the content shown on the screen of the mobile electronic device may be difficult for someone else to see and/or decipher. And again, the exterior of the mobile electronic devices may not provide information relating to the type of content and/or the specifics of that content.

Further limitations and disadvantages of conventional and traditional approaches will become apparent to one of ordinary skill in the art through the comparison of such systems with some aspects of some embodiments according to the present invention as set forth in the remainder of the present application with reference to the drawings.

### BRIEF SUMMARY OF THE INVENTION

Some embodiments of the present invention generally relate to a method and system for the sharing of information between individuals, including, for example, information regarding digital content being utilized. According to certain embodiments, the system may detect whether users of the system are in relatively close proximity to each other so as to create an at least temporary sub-community of users who are at similar locations. For example, the system may determine the current location of users via the mobile electronic devices being used by the users. Additionally, an on-line community may also be established through web-based activity. Further, the sharing of information and/or revealing of other users may be subject to qualification criteria, at least some of which may be established by the individual users. The system may allow users to share an identification of at least some of the digital content being utilized by each user, as well as reviews and recommendations of such content, so as to facilitate the sharing of information between people. The system may also provide features relating to users purchasing content utilized and/or reviewed by other users of the system. Information obtained or otherwise compiled from the users may also be used for marketing and sales purposes.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIGS. 1A-B are exemplary timelines illustrating the prior practice of reading printed media, the current practice of viewing content on electronic devices, and a certain embodiment of the present invention that utilizes a SOCIA app on a mobile electronics device.

FIG. 2 illustrates the use of a SOCIA app on a mobile electronic device according to certain embodiments of the present invention.

FIG. 3 illustrates the use of a SOCIA app on mobile electronic devices in relatively close proximity according to certain embodiments of the present invention.

FIG. 4 illustrates the use of a SOCIA app on a mobile electronic device to provide reviews and a buy button according to certain embodiments of the present invention.

FIG. 5 illustrates the use of SOCIA to provide a user profile according to certain embodiments of the present invention.

FIG. 6 illustrates the use of SOCIA on a web-based community site for exchanging information with other SOCIA users according to certain embodiments of the present invention.

FIG. 7 illustrates a best price search engine for SOCIA according to certain embodiments of the present invention.

The foregoing summary, as well as the following detailed description of certain embodiments, will be better understood when read in conjunction with the appended drawings. For the purpose of illustrating the present invention, there is shown in the drawings, certain embodiments. It should be understood, however, that the present invention is not limited to the arrangements and instrumentalities shown in the attached drawings.

### DETAILED DESCRIPTION OF THE INVENTION

The present invention will now be described more fully with reference to the accompanying drawings, in which several embodiments are shown. The present invention may, however, be embodied in many different forms and should not be construed as limited to the embodiments set forth here. Rather, these certain embodiments are examples of the present invention, which has the full scope indicated by the language of the claims.

Certain embodiments of the present invention provide a method and system for the sharing of information between individuals in user-selected area. A variety of different criteria for user-selected areas may be employed. Additionally, such user-selected area criteria may be based on the user and/or other user's past, current, and/or future location(s). For example, according to certain embodiments, the user-selected area may be based on a criteria relating to the distance/area between/containing users and/or electronic devices (e.g., mobile devices, stationary devices, wired and/or wireless devices, cellular devices, etc.), such as, for example, whether users are 100 feet apart or within a 5 mile radius, among other distance related criteria. Additionally, the user-selected area may be based on geographic criteria, such as, for example, users/electronic devices that have been, are, or will be present in a particular neighborhood, town, city, state, region, and/or country, among other geographic criteria. The user-selected area criteria may also be based on types of locations, such as, for example, users present at particular airport, airplane, train, business, café, hotel, establishment, and/or venue, among other locations. According to certain embodiments, an application (also commonly referred to as an “app”) for a mobile electronic device may allow users of the app to share information with other users of the app (relating to the content they are utilizing. Again, according to certain embodiments, eligibility to sharing such information may be subject to satisfaction of user-selected area criteria, among other criteria. For at least purposes of illustration, the app that may be utilized by the users of the mobile electronic devices may be referred to as the SOCIA app. Further, the content being utilized by the user may be automatically detected and/or recorded by the SOCIA app and/or may be manually inputted into the SOCIA app by the user.

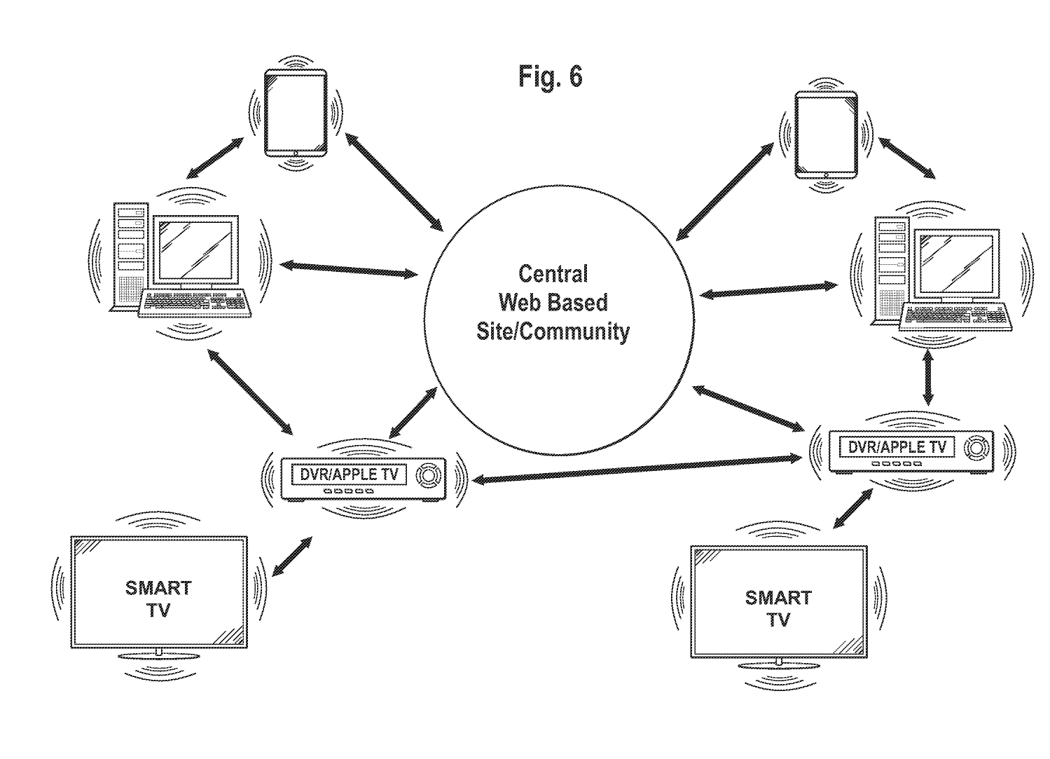

Similarly, according to certain embodiments, users of the present system may also connect with each other, and utilize features described above and below in connection with the SOCIA app, through an internet based SOCIA community, as shown, for example, in FIG. 6. For example, such a SOCIA community may include a website on which SOCIA users may exchange, transmit, download, or otherwise share and communicate information, purchase digital and non-digital content, search for best prices for such content, and/or receive general and/or target messages and offers from merchants. Such information may include a record of at least a portion of the content that is, or had been, utilized by the user. These features are not necessarily exclusive to the internet based SOCIA community. Any and all of the above features may all be part of the SOCIA app for mobile devices as well.

The SOCIA app and SOCIA web-based community (collectively referred to as “SOCIA”) may be configured to allow individual users of SOCIA to share with other SOCIA users information regarding the digital content that the individual is reading, watching, and/or listening to on their mobile and/or non-mobile electronic device(s). Additionally, according to certain embodiments, SOCIA may be configured to allow users of SOCIA to rate and/or review and/or recommend such digital content. Further, according to certain embodiments, SOCIA may also be configured to allow users to purchase digital content via a SOCIA affiliate, such as, for example, e-retailer programs. According to such embodiments, SOCIA and/or the SOCIA app associate retailer may reward a SOCIA user who influenced or otherwise encouraged a sale of content to another SOCIA user, such as, for example, via recommending the content or disclosing the content to the purchaser. Such rewards may include, but are not limited to, providing credit and/or money to the SOCIA user.

According to certain embodiments, the SOCIA may be part of, accessed, and/or executed by a system of the electronic device. Further, according to certain embodiments, the system may include a processor and an input for allowing an individual to input or transfer information into the system. For example, the input may be a touch screen, keyboard, keypad, sensor, graphical interface, computer mouse, visual-tagging via Google Glass/similar style device, or scanner, among other input devices that may provide information to the system and/or allow for the selection of information in the system. Information, instructions, or other data may also be communicated to the system through the use of a bus. For example, information inputted or selected the through use of the input may be transferred to the processor or other component of the system via a bus.

The system may also include a memory, which may or may not be part of the processor. The memory may store the SOCIA app, the location of SOCIA, and/or instructions or information relating to accessing or communicating with SOCIA, as well as other programming, instructions, or other information that is used or executed by the processor. For example, the memory may store data relating to the digital content and/or the location of the digital data being utilized by a user of the electronic device, as well as information relating to the digital content. According to certain embodiments, the memory may be a non-transitory computer-readable storage medium. Suitable memories include, but are not limited to, permanent memory, RAM, ROM, or a hard drive, among others. The system may also include an output, such as, for example, a port and/or cable that may be used in the delivery of information, such as for example, the digital content or information relating to the digital content, from the system to another system, device, machine, or other non-transitory computer-readable storage medium. The output may also include components configured for conveying visual and/or audible information to the user, such as, for example, a monitor and/or screen that visually displays information, and audio port, and/or speakers.

Further, according to certain embodiments, the electronic device may include a transceiver, modem, among other networking or communication devices, that is configured to transmit and/or receive information. For example, the networking device may allow for communication with a server and/or other electronic devices, including, for example, communications over the internet or via a cellular network, among other networks.

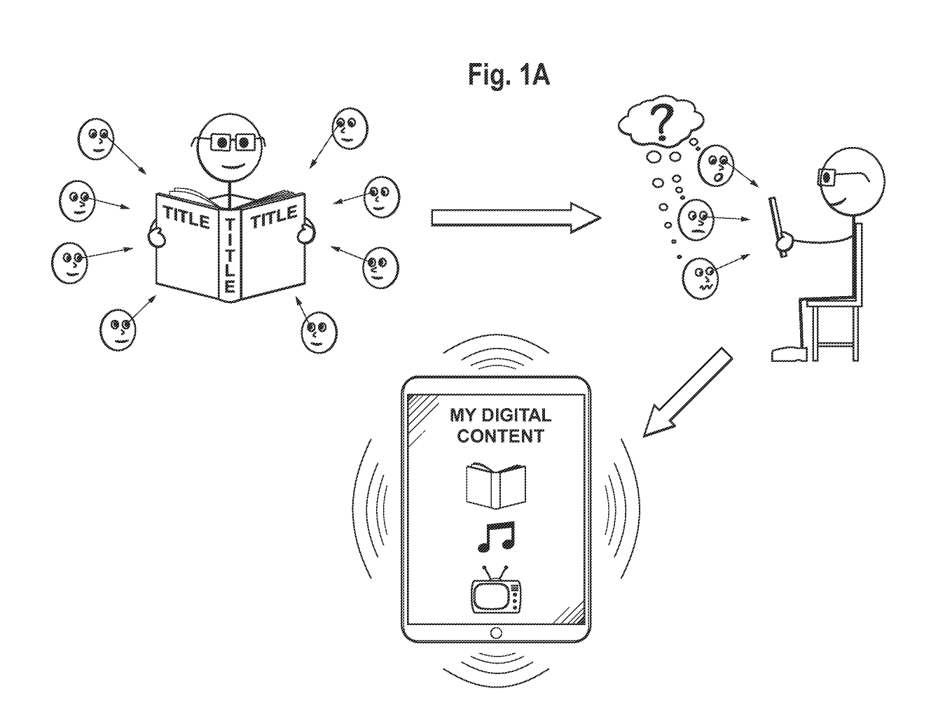

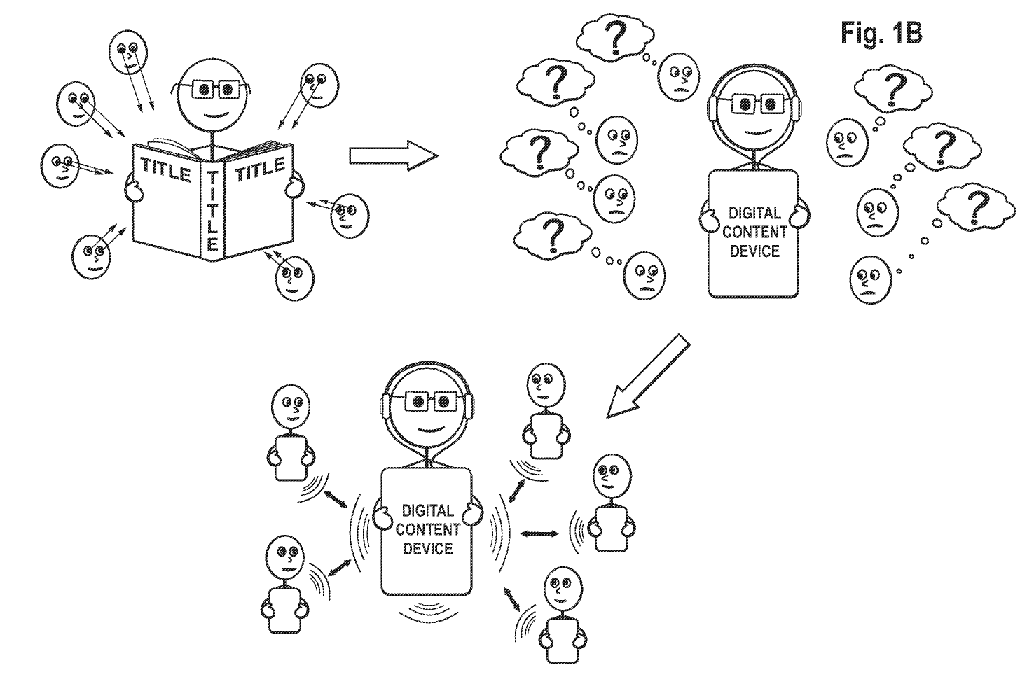

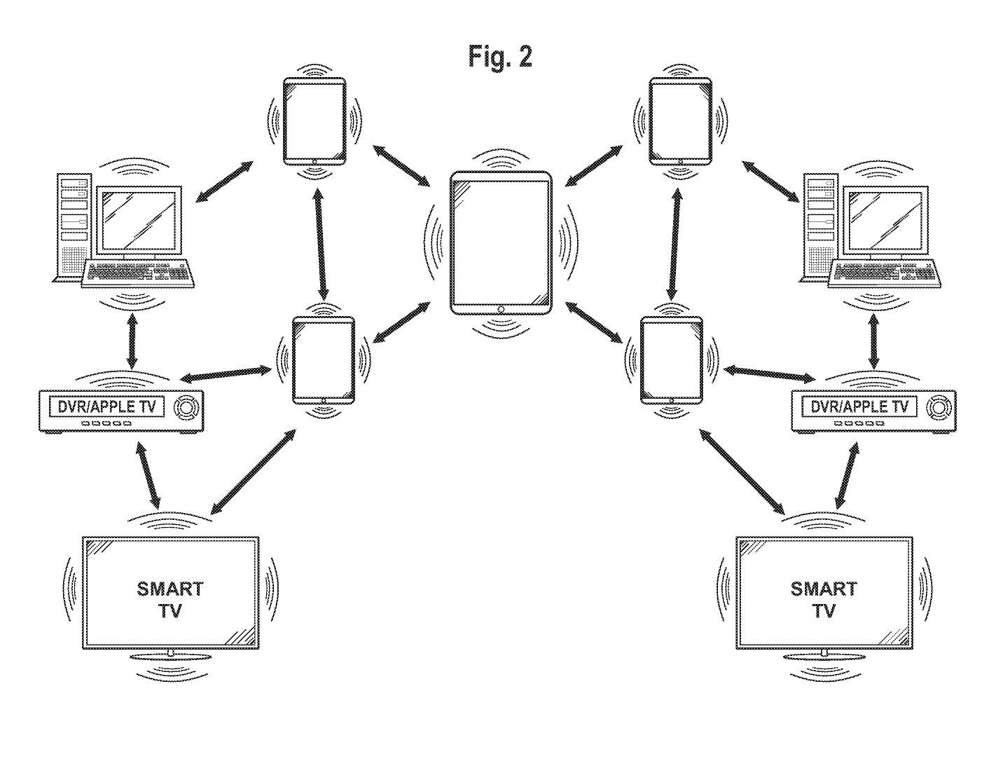

Referencing FIGS. 1A-3, According to certain embodiments, SOCIA may be configured for content information, such as a record, to be transmitted to, from, and/or between users of SOCIA through electronics devices or other hardware associated with SOCIA itself. Further, according to certain embodiments, the receipt and/or exchange of content information may be based on certain criteria, including, for example, the proximity of mobile electronic devices that are using the SOCIA app, the proximity of a home location of the SOCIA users, and/or a designation location for the users. For example, according to certain embodiments, content being viewed by a SOCIA app user on a mobile phone, tablet, computer, and other electronic devices may be transmitted to and/or received from other SOCIA app users who, with their mobile electronic device, are in close proximity to the user, such as, for example, who are on/in the same train, bus, café, building, room, block, flight, or hotel, among other locations. The determination of the location of SOCIA users may be determined in a variety of different manners, including for example, through the use of a global positioning system (GPS), assisted GPS, synthetic GPS, geofencing, location-based services, TRANSLOCAL targeting technology, cell ID via associating the location of the electronic device with a cell tower, Wi-Fi such as via a received signal strength indication or wireless fingerprinting, inertial sensors, barometer, ultrasonic, Bluetooth beacons, and/or terrestrial transmitters, among others.

Additionally, according to certain embodiments, the SOCIA app, when activated, is configured to, with the mobile or stationary electronic device, function like radar. Moreover, the SOCIA app may provide instructions for the electronic device to emit a signal, such as via a cellular, Wi-Fi, or Bluetooth network, among other networks, that is indicative of a search or identification for/of other SOCIA app users.

Further, according to certain embodiments, SOCIA may be configured to allow the user to establish criteria regarding information that user is to receive. For example, a first SOCIA user may require that he/she not receive information from other SOCIA users unless those other users satisfy an eligibility criteria set by the first user. For example, a SOCIA app user may request that he/she not receive information regarding other SOCIA app users, including notification of their presence, unless those other users satisfy particular reading habits and/or interest requirements, such as, for example, requiring information from on those users who have an interest in a particular author and/or genre of literature.

Additionally, SOCIA may be configured to control when a SOCIA user may be revealed to other users. Such control may be based on criteria established by either the party that is to be revealed and/or the party seeking identification of another SOCIA user. For example, a SOCIA user may configure SOCIA to only disclose that user's presence and/or reveal information regarding that user to other SOCIA users who: read a particular newspaper or authors; visit certain websites and blogs; watch certain movies, actors, or shows; or listen to particular artists, among other criteria. Additionally, a SOCIA user may set SOCIA to seek and/or identify other SOCIA users who satisfy similar criteria, such as, for example, identify only SOCIA users who read a particular newspaper.

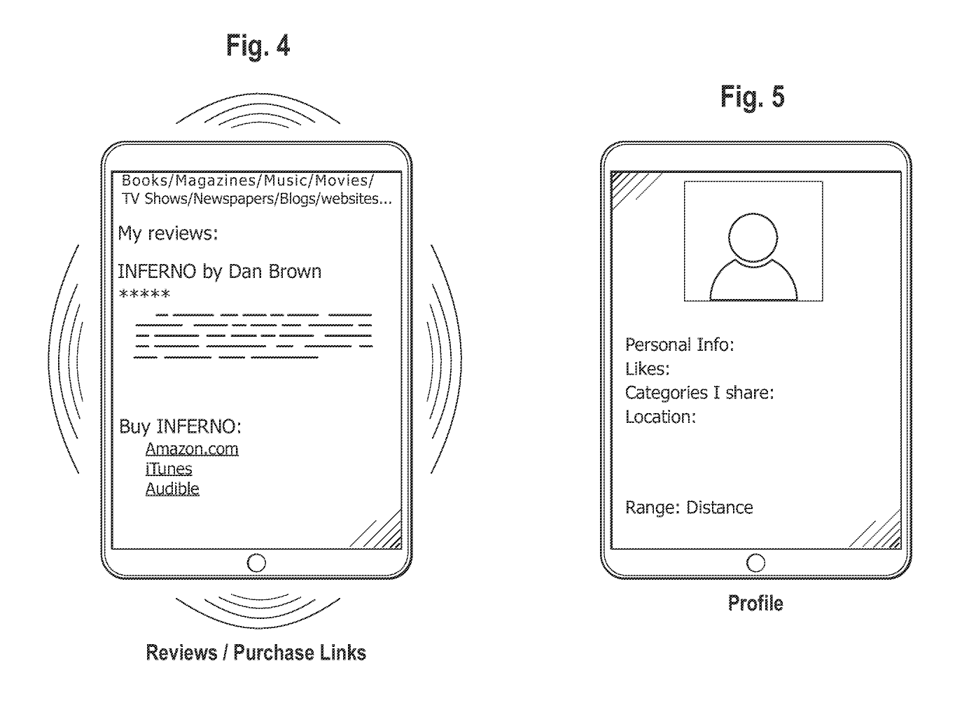

Further, SOCIA may be configured to allow the SOCIA user to have the option of creating a screen name or remain anonymous. Referencing FIG. 5, the SOCIA user may create a user profile that may list a variety of personal information and user preferences, such as, for example, the user's age, gender, education, employment, as well as upload a photo(s), among other information. However, the SOCIA user may control the extent, or to whom, any or all such personal information may be revealed to other SOCIA users. For example, a first SOCIA user may elect to reveal at least certain personal information only to other SOCIA users who have a profile completed and made public personal information to the same degree as the first SOCIA user.

For example, while traveling via train, the mobile electronic device of a first person having the SOCIA app, or other hardware associated with the SOCIA app, may receive information that is used by the SOCIA app to indicate the presence of second and third SOCIA app users on the train and/or in the same train car. However, the first SOCIA app user may limit the detection and/or identification of such second and third SOCIA app users by requiring that the second and third SOCIA app users satisfy particular criterion, such as, for example, criteria regarding the type of music the users have listened to within the last month. Further, the second and third SOCIA users may limit their detection and/or identification to the first SOCIA app user (or each other) by requiring that they only be identified to SOCIA app users who read books by a particular author. Depending on satisfaction of such criteria (among other possible criteria), the second and/or third SOCIA app users may or may not be identified to the first user, and the first user may or may not be identified to the second and/or third SOCIA app users, and the second and third SOCIA app users may or may not be identified to each other.

In the event the SOCIA app users are identified to each other and eligible to receive/exchange information, the SOCIA app may be used in connection with information being transmitted from and/or received by the eligible SOCIA app users. According to certain embodiments, such information shared with the SOCIA app users may include, but is not limited to: the current book(s), newspapers, and/or articles being read by the first user (as well as the percentage complete of each); a user history of books, magazines, and/or articles read, such as over a period of time including over the last week, month, year, and/or lifetime; favorite/starred articles; history of blog and websites visited; articles saved for later viewing/reading; reviews, thoughts, and/or comments regarding materials read; playlists; music being listened to; television shows, webisodes, movies, and video clips being watched; and, favorite shows, movie, and favorite bands. Again, however, the SOCIA user, and in this particular example, the SOCIA app users, may have the ability to control the extent any such information is shared.

Thus, SOCIA may allow a variety of different individuals, such readers and/or music, TV, film, and other digital content lovers to connect and exchange, distribute, and/or receive information. Moreover, SOCIA may allow users from a variety of backgrounds and different digital content habits to connect.

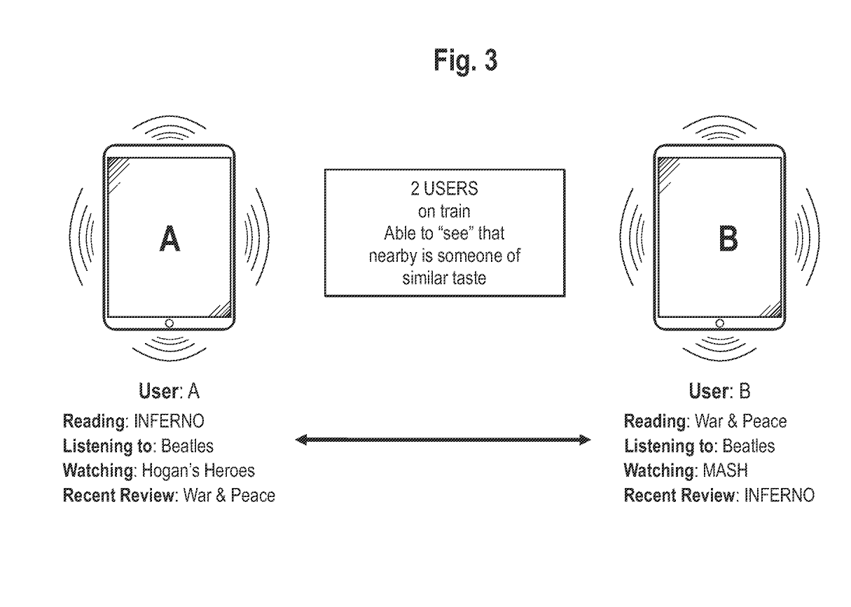

SOCIA may also be configured to provide a financial incentive for SOCIA users to use SOCIA and provide feedback regarding content a user has utilized. For example, referencing FIG. 4, at least a portion of SOCIA users may be encouraged to critique, evaluate, rate, and/or review/recommend the content that they are utilizing, such as, for example, the content they are listening to, reading, or watching. Further, SOCIA users may be able to provide commentary on, as well as give “likes” to other SOCIA users' reviews/ratings. For example, according to certain embodiments, SOCIA user A may provide a review of a particular content, such as, for example, the latest novel by author Brad Thor or a Justin Timberlake album. User A's review may compel SOCIA user B to purchase that reviewed content. SOCIA may be configured for user B to activate a buy button associated with user A, such as, for example, by pressing or clicking on the buy button. After activating the buy button, according to certain embodiments, a list of e-retailers affiliated to with SOCIA and/or having an actual or potential relationship with user A may be presented. User B may then choose an e-retailer, such as Amazon.com, BarnesandNoble.com, iTunes.com, Audible.com, among others, to use in buying the content user A reviewed. User A may then get credit for the sale to user B, such as in the form of money or credit toward user A's next purchase with that e-retailer. Further, SOCIA may be adapted to allow user B to provide comments regarding user A's review.

In addition to the detection and/or identification of other SOCIA users that are located in generally the same proximity, SOCIA may allow for instant “text” style messaging, electronic “e-mail” style messaging, on-line communications, and/or other forms of information exchanges. Moreover, SOCIA users may be able to friend each other and share information with anyone anywhere on the SOCIA site—i.e. their experience and interaction may not be limited to only SOCIA users in their general/immediate proximity.

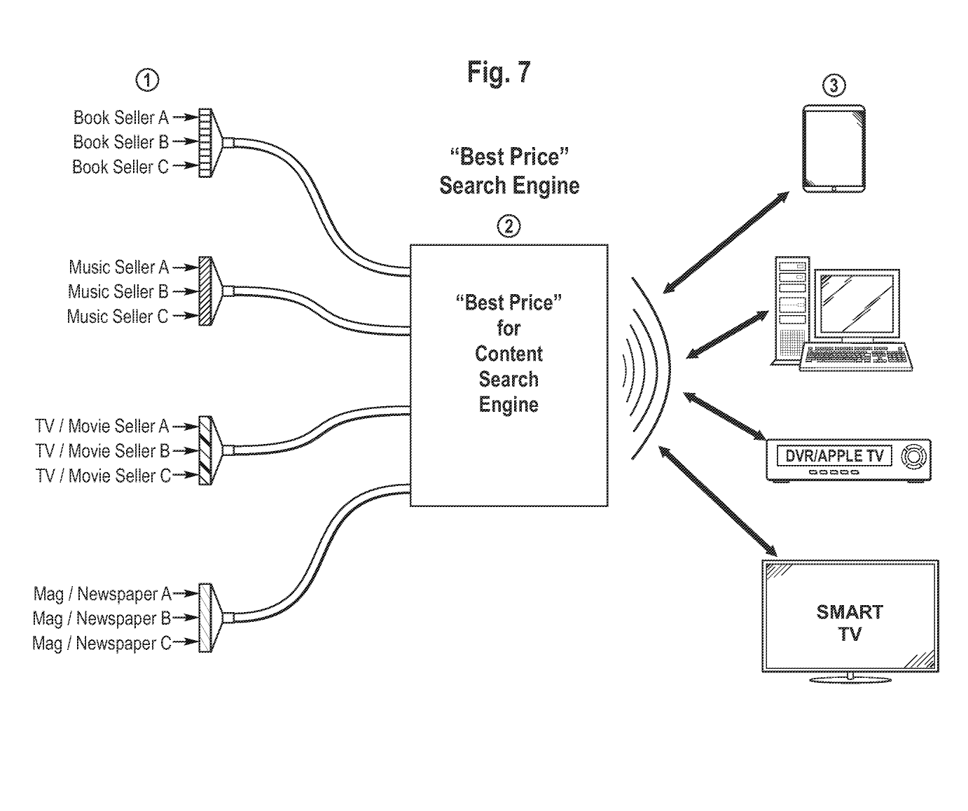

Additionally, referencing FIG. 7, SOCIA may also be configured to include a “Best Price” search engine that may search the internet for the lowest prices on whatever particular content the SOCIA user is looking for. The SOCIA “Best Price” search engine may also expand beyond digital content and into other non-digital merchandise and services.

Further, according to certain embodiments, SOCIA may be utilized by merchants, such as sellers of products and/or services. For example, the merchants may utilize the proximity feature of the SOCIA app to provide a message to a SOCIA app user who is near one of the merchant's retail outlets and/or distributions points, among other possibilities. The message may include a variety of different information and may contain general information or information that is specifically targeted toward that particular SOCIA user. Further, information provided by, or obtained from the SOCIA user may be used to develop a user profile so that targeted messages and offerings may be sent to that user. The profile may be based at least in part on the content that the SOCIA user is reading, listening to, and/or watching, the user's review of content and previously indicated “likes,” as well as preferences provided by the user, established routes and modes of the user's travel, previous physical locations the user has occupied, as well as other information. Accordingly, SOCIA may include features allowing for searching of users that have previously provided an indication of “likes” for particular content, products, and/or subjects, among searches of other categories of information.

For example, SOCIA may be configured for a SOCIA and/or a merchant to send a user a message that provides notification of current sales or price discounts being offered by the merchant. The message may also indicate homes for sale that are in proximity to the SOCIA app user's current location or homes within that location that satisfy certain criteria such as sales price, number of bedrooms, among other criteria, based on information provided by, or obtained from, the SOCIA user. Thus, for example, when traveling with their mobile electronic device, the SOCIA app on the mobile electronic device may receive a message from a realtor of homes within 10 miles of the user's present location that may meet particular requirements of that SOCIA user.

According to another example, if a SOCIA user had previously used SOCIA in indicating he/she “liked” or rated a food article, a grocery store in proximity to the SOCIA user could send a message to the SOCIA user, such as to the electronic device of the SOCIA app user or the SOCIA user's profile, encouraging the user to visit their grocery store to purchase the ingredients as well as offering a coupon for at least some of those ingredients. SOCIA may also be configured to allow the user to agree to, or opt out of, receiving these types of merchant communications.

Some embodiments according to the present invention may be realized in hardware, software, firmware, or a combination of hardware, software or firmware. Some embodiments according to the present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

Some embodiments according to the present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: (a) conversion to another language, code or notation; and (b) reproduction in a different material form.

While some embodiments according to the present invention have been described with reference to certain embodiments, it will be understood by those skilled in the art that various changes may be made and equivalents may be substituted without departing from the scope of the present disclosure. In addition, the present disclosure contemplates that aspects and/or elements from different embodiments may be combined into yet other embodiments according to the present invention. Moreover, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

1. A method for sharing information between individuals, comprising:
storing a record of at least a portion of the content utilized by a first user on a first device; detecting a second user;
accessing, using a second device of a second user, the record; and
displaying, on a display of the second device, at least a portion of the accessed record.

2. The method of claim 1, wherein the content includes one or more of the following digital content: a book, magazine, newspaper, article, and/or author read by the first user; one or more songs and/or artists listened to by the first user; one or more videos, television shows, webisodes, and/or movies watched by the first user; one or more websites and/or blogs viewed by the first user.

3. The method of claim 1, wherein the step of detecting the second user includes detecting the location of the second user using one or more the of the following: a global positioning system (GPS), an assisted GPS, a synthetic GPS, geofencing, location-based services, TRANSLOCAL targeting technology, a cell ID, a received signal strength indication system, a wireless fingerprinting system, one or more inertial sensors, a barometer, a ultrasonic system, one or more Bluetooth beacon, and/or a terrestrial transmitter.

4. The method of claim 1, comprising:
creating a user profile for the first user.

5. The method of claim 1, comprising:
creating a first user criteria for eligibility of the second user to access the record; and
evaluating whether the second user satisfies the first user criteria.

6. The method of claim 5, comprising:
creating a second user criteria for eligibility of the record of the first user to be accessed by the second user, and
evaluating whether the first user satisfies the second user criteria.

7. The method of claim 1, wherein the step of detecting the second user includes determining whether the second user is generally in proximity to the first user, and further comprising:
not permitting access to the record by the second user if the second user is determined not to be in proximity to the first user.

8. The method of claim 1, wherein the first device is a first mobile device, and wherein the second device is a second mobile device.

9. The method of claim 1, comprising:
transmitting information between the first and second users via a web-based community.

10. The method of claim 1, comprising:
recording a review of the first user of content utilized by the first user.

11. The method of claim 10, comprising:
accessing, by the second user using the second device, the recorded review of the first user.

12. The method of claim 1, comprising:
activating, by the second user via an input of the second device, a buy button to purchase at least a portion of the content identified by the record.

13. The method of claim 12, comprising:
providing an award to the first user for the purchase of the content by the second user.

14. The method of claim 12, comprising:
searching the Internet for prices being offered for the content being sought to be purchased by the second user.

15. The method of claim 1, comprising:
compiling information from the first user and/or the second user.

16. The method of claim 15, comprising:
utilizing the compiled information to provide one or more products and/or service offers from one or more merchants to the first user and/or the second user.

17. The method of claim 1, comprising:
searching for and obtaining reviews provided by the first and/or the second users; and
determining products and/or service offerings for the first and/or second users based, at least in part, on the obtained reviews.

18. A system for sharing information between individuals, comprising:
a first device configured to record digital content utilized by a first user on the first device;
a second device configured to record digital content utilized by a second user on the second device; and
a network configured for two-way communications between the first device and the second device, the communications including records that indicate at least a portion of the digital content utilized by the other of the first user and the second user.

19. The system of claim 18, wherein the content includes one or more of the following digital content: a book, magazine, newspaper, article, and/or author read by the first user; one or more songs and/or artists listened to by the first user; one or more videos, television shows, webisodes, and/or movies watched by the first user; one or more website and/or blogs viewed by the first user.

20. The system of claim 18, wherein the system is configured to detect the location of the first user and the second user.

21. The system of claim 20, wherein the system utilizes one or more of the following to detect the position of the first and second users: a global positioning system (GPS), an assisted GPS, a synthetic GPS, geofencing, location-based services, TRANSLOCAL targeting technology, a cell ID, a received signal strength indication system, a wireless fingerprinting system, one or more inertial sensors, a barometer, a ultrasonic system, one or more Bluetooth beacon, and/or a terrestrial transmitter.

22. The system of claim 18, wherein the system is configured to record a user profile for the first user and/or the second user.

23. The system of claim 18, wherein the system is configured to record a first user criteria for eligibility of the second user to access a record of the first user and to evaluate whether the second user satisfies the first user criteria.

24. The system of claim 23, wherein the system is configured to record a second user criteria for eligibility of a record of the first user to be accessed by the second user, and wherein the system is configured to evaluate whether the first user satisfies the second user criteria.

25. The system of claim 18, wherein the system is configured to determine whether the second user is generally in proximity to the first user, and comprising:
not permitting access to the record by the second user if the second user is determined not to be in proximity to the first user.

26. The system of claim 18, wherein the first device or the second device is a mobile device.

27. The system of claim 18, wherein the system is configured to record a review of the first user of the content utilized by the first user.

28. The system of claim 27, wherein the system is configured to allow, if eligibility criteria is satisfied, the second user using the second device to access the recorded review of the first user.

29. The system of claim 18, wherein the system is configured to display on the display of the second device a buy button for the second user to activate via an input of the second device to purchase at least a portion of the content identified by the record of the first user.

30. The system of claim 29, wherein the system is configured to provide an award to the first user for the purchase of the content by the second user.

31. The system of claim 29, comprising:
a search engine configured to search the Internet for prices being offered for the content being sought to be purchased by the second user.

32. The system of claim 18, wherein the system is configured to compile information from one or more of the following: the first user and the second user.

33. The system of claim 32, wherein the system is configured to utilize the compiled information to provide one or more product offers and/or service offers from one or more merchants to the first user and/or the second user.

34. The system of claim 18, wherein the system is configured to search for and to obtain reviews provided by the first user and/or the second user, and wherein the system is configured to determine products and/or service offerings for the first user and/or the second user based, at least in part, on the obtained reviews.
